(19) United States
(12) Patent Application Publication
(10) Pub. No.: US 2018/0284082 A1
(43) Pub. Date: Oct. 4, 2018

(54) HIGH-SPEED GAS SAMPLE ANALYSIS DEVICE USING GAS CHROMATOGRAPHY, AND METHOD THEREOF

(71) Applicant: LG CHEM, LTD., Seoul (KR)

(72) Inventors: Jong-Mo JUNG, Daejeon (KR); Jeong-Ae AHN, Daejeon (KR); Jong-Hoa OK, Daejeon (KR)

(21) Appl. No.: 15/765,986

(22) PCT Filed: Oct. 6, 2016
(86) PCT No.: PCT/KR2016/011215

§ 371 Date: Apr. 4, 2018

(30) Foreign Application Priority Data
Oct. 6, 2015 (KR) 10-2015-0140639

(51) Int. Cl. G01N 30/66; G01N 30/68; H01M 10/48; G01N 25/18; G01N 30/78

(52) U.S. Cl. CPC G01N 30/66; G01N 30/68; G01N 2030/025; G01N 25/18; G01N 30/78; H01M 10/48

(57) ABSTRACT

The present invention relates to an apparatus for a high-speed analysis of gas samples using gas chromatography comprising: an organic gas analyzing part comprising a switching valve, a column, and a flame ionization detector (FID); and a fixed gas analysis part comprising a plurality of switching valves, three or more columns comprising a column for electrolyte separation, a column for carbon dioxide separation, and a column for separating fixed gas, a pressure controller, and a thermal conductivity detector (TCD), and an analyzing method using the same.

### TECHNICAL FIELD

The present application claims the benefit of priority to Korean Patent Application No. 10-2015-0140639, filed on Oct. 6, 2015, which is incorporated herein by reference in its entirety for all purpose.

The present invention relates to an apparatus for a high-speed analysis of a gas sample using gas chromatography. More specifically, the present invention relates to an apparatus for a high-speed analysis of a gas sample using a gas chromatograph capable of analyzing in a short time by controlling a direction and sequence of a gas sample flow to be analyzed using a plurality of columns.

### BACKGROUND ART

In an operation of a lithium ion battery, gas components such as hydrogen, oxygen, nitrogen, carbon monoxide, carbon dioxide, methane, ethane, ethylene, propane and the like are generated. Information on the composition and content of such generated gas may be usefully available for research and development of a battery material, optimization of battery manufacturing processes, and identification of a cause of a battery failure.

Inside such a lithium secondary battery, gas components such as hydrogen, oxygen, nitrogen, carbon monoxide, carbon dioxide, methane, ethane, ethylene, propane and the like are mixed with vaporized electrolyte components, and, in order to analyze them, it is needed to clearly separate them by a gas chromatography (GC) column. The currently used technologies are cooling the temperature of the column to −60° C. or less by using liquid nitrogen for the separation of each gas species and carrying out an analysis for more than 1 hour, and thereby, there were problems that an automation of the analysis is difficult and the processing speed of the sample is slow.

Therefore, it is urgent to study analytical instruments using gas chromatography, which can carry out analysis at a temperature higher than or equal to a room temperature within a short time, without using liquid nitrogen and methods thereof.

### DISCLOSURE

### Technical Problem

In order to solve the problems of the prior arts as described above, an object of the present invention is to provide an apparatus for a high-speed analysis of a gas sample using gas chromatography capable of analyzing a gas generated inside a cell at a temperature higher than or equal to a room temperature within a short time without using liquid nitrogen and a method thereof.

### Technical Solution

In order to achieve the above object, the present invention provides an apparatus for a high-speed analysis of a gas sample using gas chromatography comprising: an organic gas analyzing part comprising a switching valve, a column, and a flame ionization detector (FID); and a fixed gas analysis part comprising a plurality of switching valves, three or more columns comprising a column for electrolyte separation, a column for carbon dioxide separation, and a column for fixed gas separation, a pressure controller of a mobile phase gas, and a thermal conductivity detector (TCD).

Further, the present invention provides a method for a high-speed analysis of a gas sample using gas chromatography comprising the steps of: a) injecting a mixed gas of an organic gas and a fixed gas; b) sending a portion of the injected gas into a column for organic gas separation and separating the organic gas, and then analyzing the separated organic gas with a flame ionization detector (FID); c) separating the injected gas by sending it into the column for electrolyte separation, the column for carbon dioxide separation, and the column for fixed gas separation; d) discharging the electrolyte remaining in the column for electrolyte separation; e) separating the carbon dioxide with the column for carbon dioxide separation and bypassing it to a thermal conductivity detector (TCD); and f) separating the fixed gas with the column for fixed gas separation and then sending it to a thermal conductivity detector (TCD).

### Advantageous Effects

According to the apparatus for a high-speed analysis of a gas sample using gas chromatography of the present invention, there are advantages that it is not necessary to cool down to −60° C. or lower by using liquid nitrogen, and the electrolyte remaining in the column can be removed while performing at a temperature higher than or equal to a room temperature, and an analyzing within a shorter time than the prior art is possible, by preferentially analyzing the essential analysis object.

Also, according to the apparatus for a high-speed analysis of a gas sample using gas chromatography of the present invention, there are advantages that, when completely separating the components constituting the organic gas and detecting them with the flame ionization detector (FID), the respective organic gases can be completely separated without interference each other.

Further, according to the apparatus for a high-speed analysis of a gas sample using gas chromatography of the present invention, there are advantages that, when completely separating the components constituting the fixed gas and detecting them with thermal conductivity detector (TCD), the respective fixed gases can be completely separated without interference each other.

### DESCRIPTION OF DRAWINGS

FIG. 1 illustrates an apparatus for a high-speed analysis of a gas sample according to an embodiment of the present invention.

FIG. 2 illustrates an organic gas analyzing part in an apparatus for a high-speed analysis of a gas sample according to an embodiment of the present invention.

FIG. 3 illustrates a fixed gas analyzing part in an apparatus for a high-speed analysis of a gas sample according to an embodiment of the present invention.

FIG. 4 illustrates a fixed gas analyzing part in an apparatus for a high-speed analysis of a gas sample according to an embodiment of the present invention.

FIG. 5 illustrates a fixed gas analyzing part in an apparatus for a high-speed analysis of a gas sample according to an embodiment of the present invention.

FIG. 6 illustrates a fixed gas analyzing part in an apparatus for a high-speed analysis of a gas sample according to an embodiment of the present invention.

FIG. 7 is a graph showing the analysis results of the organic gases obtained from the organic gas analyzing part.

FIG. 8 is a graph showing the analysis results of the fixed gases obtained from the fixed gas analyzing part.

### MODE FOR INVENTION

Hereinafter, an apparatus for a high-speed analysis of a gas sample using gas chromatography and a method for a high-speed analysis of a gas sample using gas chromatography by using the same according to the present invention will be described in detail.

The following detailed description is only an example of the present invention. Thus, although there is a definite expression, it does not limit the scope of the right defined by the claims.

Throughout the Figures of the present invention, similar reference numbers refer to the similar elements.

In the present invention, the term “and/or” means comprising any one or a combination of a plurality of the described contents.

In the present invention, when an element is referred to as being “connected” or “coupled” to another element, it is understood that the element may be directly connected or coupled to the another element or be connected or coupled to another element via the other element.

In the present invention, the singular expressions include plural expressions unless otherwise specified.

In the present invention, the terms “comprising”, “comprising”, or “having” mean that there is a feature, a numerical value, a step, an operation, an element, a component or a combination thereof described in the specification, and do not preclude a possibility that other features, numbers, steps, operations, components, parts, or combinations thereof may be present or added.

In the present invention, “chromatography” refers to physical separation in which a single component is separated from an analyte using the difference in affinity between a stationary phase and a mobile phase of the analyte to be analyzed, and particularly refers to gas chromatography in case that the mobile phase is a gas phase (gas), and the gas chromatography may include the case that the stationary phase is a liquid phase or a solid phase.

In the prior art, there is a problem that, when analyzing the composition and content of the fixed gas and the organic gas, etc. in gas components generated inside the cell during an operation of a lithium ion battery, it takes a long time, for example, one hour or longer, in accordance with the separation of the fixed gas species, the column cooling time, the long retention time of the electrolyte components, etc. Accordingly, the present inventors have made an effort to solve the above-mentioned problems, and have found that this can be solved by respectively separating and analyzing the fixed gas and the organic gas among the gas components and thereby analyzing them within a short time, i.e., within 15 minutes.

More specifically, the present invention is featured by an apparatus for a high-speed analysis of gas samples using gas chromatography comprising: an organic gas analyzing part comprising a switching valve, a column, and a flame ionization detector (FID); and a fixed gas analysis part comprising a plurality of switching valves, three or more columns comprising a column for electrolyte separation, a column for carbon dioxide separation, and a column for separating fixed gas, a pressure controller of a mobile phase gas, and a thermal conductivity detector (TCD).

Hereinafter, the present invention will be described more specifically with reference to the Figures.

First, the organic gas analyzing part of the present invention has a configuration comprising a switching valve, a column, and a flame ionization detector (FID), and analyzes an organic gas.

There is no particular limitation on the organic gas as long as it is the organic gas to be analyzed in the art. Preferably, the organic gas may be any one or more selected from the group consisting of CₙH₂ₙ₋₂ (n=2 to 5), CₙH₂ₙ (n=2 to 5), and CₙH₂ₙ₊₂ (n=1 to 5).

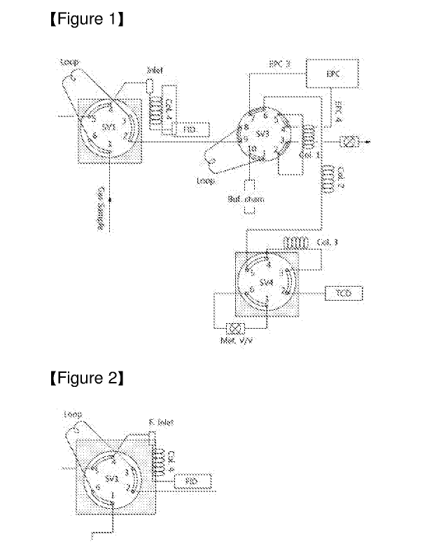

The organic gas analyzing part of the present invention includes a switching valve, a column, and a flame ionization detector (FID) as shown in the left side of FIG. 1.

First, the switching valve of the organic gas analyzing part is not particularly limited as long as it is a valve used in the art. Preferably, a six-port valve to a ten-port valve may be used. It can be controlled that the gas to be analyzed is sent into the analyzing apparatus of the present invention by using the switching valve, and it can be controlled that the gas is sent into the column and the flame ionization detector described later.

In the column of the organic gas analysis part of the present invention, the fixed gas in the mixed gas of the fixed gas and the organic gas is not detected by the flame ionization detector described later, and only the organic gas may be detected by the flame ionization detector described later. The column included in the organic gas analysis part is not particularly limited as long as it can absorb the organic gas with a valve used in the art. Preferably, the PLOT (Porous Layer Open Tubular)-based column in which an inner diameter of the column is 1 mm or less and a coating thickness of the stationary phase of 5 to 50 μm, may be used.

According to the organic gas analysis of the present invention, when the gas sample to be analyzed is moved through the column by the mobile phase gas, the moving velocity is varied by the interaction with the coating layer inside the column, and thereby the respective components in the gas sample are separated. Hydrogen, helium, nitrogen, and argon may be used as the mobile phase gas. When detecting the organic gas using the flame ionization detector (FID), using hydrogen or helium as the mobile phase gas is advantageous in a view of detection sensitivity, and, using argon as the mobile phase gas is advantageous in a view of simultaneously using the fixed gas detection part and the mobile phase gas as well as increasing detection sensitivity in detecting hydrogen of the fixed gas.

The flame ionization detector (FID) in the fixed gas detection part of the present invention is most widely used in gas chromatography, and has the characteristics of being superior in the mass-sensitivity to the concentration-response, because it responds to the number of carbon atoms entering the detector per unit time. The flame ionization detector (FID) may be connected in parallel or in series with other types of detectors, such as a thermal conductivity detector (TCD), if desired.

The apparatus for a high-speed analysis of a gas sample of the present invention can completely separate each of the organic gases without interference with each other, when completely separating components constituting the organic gas through the organic gas analyzing part and detecting them with the flame ionization detector (FID).

Next, the fixed gas analysis part of the present invention comprising a plurality of switching valves, three or more columns comprising a column for electrolyte separation, a column for carbon dioxide separation, and a column for separating fixed gas, a tube enabling the separated carbon dioxide to bypass without passing through the column for fixed gas separation, a pressure controller of a mobile phase gas, and a thermal conductivity detector (TCD), and is served to analyze fixed gas.

The fixed gas means a gas component that is generally present in the air of the natural world as a relative concept of organic gas.

There is no particular limitation on the fixed gas as long as it is the fixed gas to be analyzed in the art. Preferably, the fixed gas may be any one or more selected from the group consisting of hydrogen (H₂), oxygen (O₂), nitrogen (N₂), carbon monoxide (CO), and carbon dioxide (CO₂).

The fixed gas analysis part of the present invention comprising the plurality of switching valves, three or more columns comprising the column for electrolyte separation, and the column for carbon dioxide separation and the column for separating fixed gas, the pressure controller of a mobile phase gas, and the thermal conductivity detector (TCD), as shown in the right side of FIG. 1.

First, the switching valve of the fixed gas analyzing part of the present invention may be two or more, and is not particularly limited as long as it is a valve used in the art. Preferably, a six-port valve to a ten-port valve may be used. Also, the switching valve of the organic gas analyzing part further comprises a gas loop for collecting a gas sample to be analyzed. There is no particular limitation on the material and shape of the gas loop, and it may be made of a material which does not change its shape and volume, have a volume of 0.1 to 1.0 mL, be vacuum-depressurized right before the gas sample is collected, and control moving of gas.

It is possible to control the gas to be analyzed to be sent into the analyzing apparatus of the present invention using the plurality of switching valves and to control the gas to be sent into the three or more columns and the thermal conductivity detector to be described later.

The pressure controller of the mobile phase gas in the fixed gas analysis part of the present invention controls the pressure of the mobile phase gas at the inlet of column for carbon dioxide separation and the column for electrolyte separation, and moves and separates the fixed gas, the organic gas and the electrolyte. The pressure controller independently respectively controls the pressure of the mobile phase gas at the inlet of column for carbon dioxide separation and the column for electrolyte separation, and an electrical pressure controller may be used. The mobile phase gas is connected to one of the switching valves of the organic gas analysis part through the pressure controller, and it is preferable to control the movement of the fixed gas, the organic gas, and the electrolyte by controlling the switching valve.

Three or more columns of the fixed gas analysis part of the present invention enable the fixed gas among the mixed gas of the fixed gas and the organic gas to be sent to a thermal conductivity detector described later.

Among the three or more columns of the fixed gas analyzing part of the present invention, the column for electrolyte separation may separate the electrolyte from the organic gas and the fixing gas, and then discharge it out of the column. In this case, preferably, the PLOT (Porous Layer Open Tubular)-based column in which an inner diameter of the column is 1 mm or less and a coating thickness of the stationary phase of 5 to 50 μm, may be used as at least two of said three columns.

The discharge of the electrolyte takes place in the column for electrolyte separation, and even after a fixed gas and a portion of the organic gas having a short retention time pass through the column for electrolyte separation to the column for carbon dioxide separation, the remaining organic gas and the electrolyte having a long retention time stay in the column for electrolyte separation. By controlling of the switching valve and making the mobile phase gas flowing through the column for electrolyte separation to flow reversely, the portion of the organic gas and the electrolyte are discharged from the column for electrolyte separation to the outside of the column. At this time, by making argon gas to be continuously flowed through the column for carbon dioxide separation by means of an independent pressure regulator, the organic gas and the fixed gas are allowed to move.

The electrolyte is vaporized inside the cell and is collected, and then exists as a vaporized state. Such an electrolytic component may affect subsequent analytical results during the continuous analysis when staying in the column, and must be discharged from the column during the analysis.

When such an electrolytic component stays in the column for a long time, it causes problems such as a long analysis time. The present invention is advantageous in that this electrolyte is discharged out of the column during the analysis, and thereby the total analysis time can be shortened to be a short time, specifically within 15 minutes, while it takes more than one hour in the prior art.

Also, among the three or more columns of the fixed gas analyzing part of the present invention, the column for the carbon dioxide separation may separate the carbon dioxide from the fixed gas and then bypass it to the thermal conductivity detector (TCD) through a bypass tube. In this case, preferably, the PLOT (Porous Layer Open Tubular)-based column in which an inner diameter of the column is 1 mm or less and a coating thickness of the stationary phase of 5 to 50 μm, may be used. In this case, after most of the fixed gas having a short retention time passes through the column and moves to the column for fixed gas separation, the carbon dioxide having a relatively long retention time also is bypassed through the bypass tube to the thermal conductivity detector (TCD) described later, without going through other columns, by the control of the above-mentioned switching valve. In the present invention, the carbon dioxide, which is an essential analysis object in the fixed gas, is first sent to the thermal conductivity detector and analyzed, and the remaining gases stay in the other columns described below and then are sent to the thermal conductivity detector and analyzed, and thereby, the total analysis time can be shortened to be a short time, specifically within 15 minutes, while it takes more than one hour in the prior art.

Further, among the three or more columns of the fixed gas analyzing part of the present invention, the column for fixed gas separation may be one in which the fixed gas is separated and then sent to a thermal conductivity detector (TCD). In this case, there is no particular limitation as long as it can separate the fixed gas with the column. Preferably, a molecular sieve having an inner diameter of 1 mm or less may be used. The thermal conductivity detector (TCD) in the fixed gas analyzing part of the present invention is a device based on the variation in the thermal conductivity of the gas flow caused by the presence of the molecules of the analytical sample, and is advantageous in that it is simple to operate, has a large linear response range, is sensitive to both organic and inorganic species, and does not destroy the sample after detection. The thermal conductivity detector (TCD) may be connected in parallel or in series with other types of detectors including a flame ionization detector (FID), if desired.

The apparatus for a high-speed analysis of a gas sample of the present invention enables to completely separate each fixed gas without interference with each other, when completely separating the components constituting the fixed gas by the fixed gas analyzing part and detecting by a thermal conductivity detector (TCD).

The apparatus for a high-speed analysis of a gas sample of the present invention may be used for analyzing a gas generated inside the cell, more specifically, for analyzing a gas generated inside the lithium ion battery.

Another aspect of the present invention is providing a method for a high-speed analysis of a gas sample using gas chromatography comprising the steps of: a) injecting a mixed gas of an organic gas and a fixed gas; b) sending a portion of the injected gas into a column for organic gas separation and separating the organic gas, and then analyzing the separated organic gas with a flame ionization detector (FID); c) separating the injected gas by sending it into the column for electrolyte separation, the column for carbon dioxide separation and the column for fixed gas separation; d) discharging the electrolyte remaining in the column for electrolyte separation; e) separating the carbon dioxide with the column for carbon dioxide separation and bypassing it to a thermal conductivity detector (TCD); and f) separating the fixed gas with the column for fixed gas separation and then sending it to a thermal conductivity detector (TCD).

The method for a high-speed analysis of a gas sample using gas chromatography of the present invention may use the apparatus for a high-speed analysis of a gas sample of the present invention.

First, the method for a high-speed analysis of a gas sample using gas chromatography of the present invention comprises a) injecting a mixed gas of an organic gas and a fixed gas.

There is no particular limitation on mixed gas used as the gas sample as long as it is a mixed gas of an organic gas and a fixed gas. Preferably, the mixed gas may be the gas generated inside the cell, more specifically, the gas generated inside the lithium ion battery.

The organic gas may be any one or more selected from the group consisting of CₙH₂ₙ₋₂ (n=2 to 5), CₙH₂ₙ (n=2 to 5), and CₙH₂ₙ₊₂ (n=1 to 5), and the fixed gas may be any one or more selected from the group consisting of hydrogen (H₂), oxygen (O₂), nitrogen (N₂), carbon monoxide (CO), and carbon dioxide (CO₂).

Next, the method for a high-speed analysis of a gas sample using gas chromatography of the present invention comprises b) sending a portion of the injected gas into a column for organic gas separation and separating the organic gas, and then analyzing the separated organic gas with a flame ionization detector (FID).

The flame ionization detector (FID) may be connected in parallel or in series with other types of detectors including a thermal conductivity detector (TCD), and it is possible to send the organic gas to a flame ionization detector (FID) using the column for organic gas separation and analyze it first. The column for organic gas separation not particularly limited as long as it can separate the organic gas with a valve used in the art. Preferably, the PLOT (Porous Layer Open Tubular)-based column in which an inner diameter of the column is 1 mm or less and a coating thickness of the stationary phase of 5 to 50 μm, may be used.

Next, the method for a high-speed analysis of a gas sample using gas chromatography of the present invention comprises c) separating the injected gas by sending it into the column for electrolyte separation, the column for carbon dioxide separation and the column for fixed gas separation.

Next, the method for a high-speed analysis of a gas sample using gas chromatography of the present invention comprises d) discharging the electrolyte remaining in the column for electrolyte separation. In such case, the fixed gas and the organic gas are sent to the column for carbon dioxide separation through the control of the control means such as the switching valve as described above and then the flow of the mobile phase gas is reversed by the operation of the valve so that the separated electrolyte is discharged from the column for electrolyte separation.

Next, the method for a high-speed analysis of a gas sample using gas chromatography of the present invention comprises e) separating the carbon dioxide with the column for carbon dioxide separation and bypassing it to a thermal conductivity detector (TCD). There is no particularly limitation on the column for carbon dioxide separation, and preferably, the PLOT (Porous Layer Open Tubular)-based column in which an inner diameter of the column is 1 mm or less and a coating thickness of the stationary phase of 5 to 50 μm, may be used. This also makes the fixed gas to be sent to the column for fixed gas separation by the control means such as the above-mentioned switching valve and then make the remaining carbon dioxide in the column to be directly bypassed to the thermal conductivity detector (TCD). According to the present invention, after only the carbon dioxide in the fixed gas is first sent to the thermal conductivity detector and is analyzed, the remaining gases stay in a column for fixed gas separation described later and then is sent to the thermal conductivity detector and is analyzed. The present invention enables the analysis to be completed within a short time, specifically within 15 minutes, compared with the conventional scheme.

Next, the method for a high-speed analysis of a gas sample using gas chromatography of the present invention comprises f) separating the fixed gas with the column for fixed gas separation and then sending it to a thermal conductivity detector (TCD). The column for fixed gas separation not particularly limited as long as it can separate the fixed gas with a valve used in the art. Preferably, the molecular sieve in which an inner diameter of the column is 1 mm or less, may be used.

### BEST MODE

Hereinafter, a preferred embodiment of the present invention will be described in order to facilitate understanding of the present invention. It will be apparent to the skilled person in the art that the following examples are illustrative of the present invention and various changes and modifications can be made within the scope and spirit of the present invention. Such changes and modifications are intended to fall within the scope of the claims.

### Example

### GC Analysis Results of Gases Inside the Cell Using an Apparatus for a High-Speed Analysis of a Gas Sample

A lithium ion battery was manufactured by using a current collector and a Li-containing compound represented by LiXMO₂ (M is at least one kind of metal selected from the metals of Groups 2 to 12 of a Periodic Table of Elements) as a positive electrode, using carbon (graphite or amorphous carbon) as a negative electrode, using a polyolefin-based film as a separation film between the positive electrode and the negative electrode, and injecting a 0.8 to 1.5 M concentration of Li salt to a carbonate-based electrolyte. After collecting the gas generated inside the lithium ion battery into a gas collecting tube, the first switching valve (ten-port valve) was opened in the ON state, and a portion of the gas was passed through the fourth column (Agilent Co., GSGasPro with a length of 30 m and an inner diameter of 0.32 mm) and injected into a flame ionization detector (Agilent Co., FID), as shown in FIG. 2.

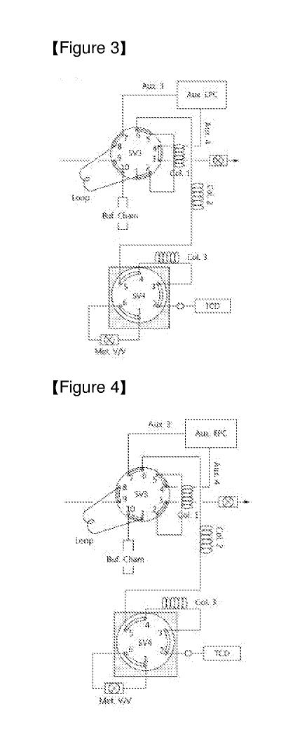

Thereafter, as shown in FIG. 3, the remainder of the gas was passed through the first switching valve and charged to the first column (Agilent Co., PLOT Q column having a length of 15 m, an inner diameter of 0.32 mm, and a stationary phase coating thickness of 20 μm), the second column (Agilent Co., PLOT Q column having a length of 15 m, an inner diameter of 0.32 mm, and a stationary phase coating thickness of 20 μm), and the third column (Agilent Co., molecular sieve 5A, length of 15 m, inner diameter of 0.32 mm, coating thickness of 0.25 μm) by controlling the third and fourth valve (ten-port valves).

Thereafter, as shown in FIG. 4, by using the third switching valve and the pressure controller (Agilent Co., Auxiliary Electronic Pressure Controller), in the first column, the direction of the flow of the mobile phase gas was to be changed and a pressure was applied, and thereby, the electrolyte was discharged out of the column.

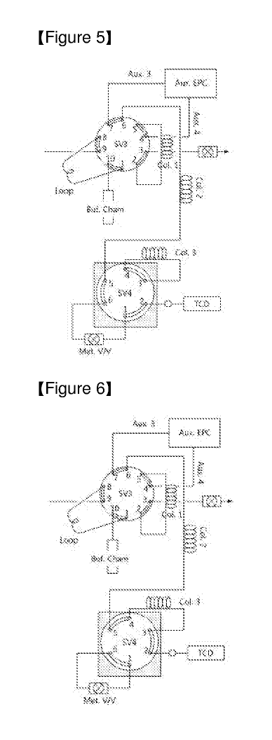

Thereafter, as shown in FIG. 5, by using the third switching valve and the pressure controller, a pressure was applied to the second column, and thereby, carbon dioxide in the second column was bypassed and directly injected into a thermal conductivity detector (Agilent Co., TCD).

Thereafter, as shown in FIG. 6, by using the fourth switching valve and the pressure controller, a pressure was applied to the third column, and thereby, the fixed gas in the third column was separated and then was directly injected into a thermal conductivity detector.

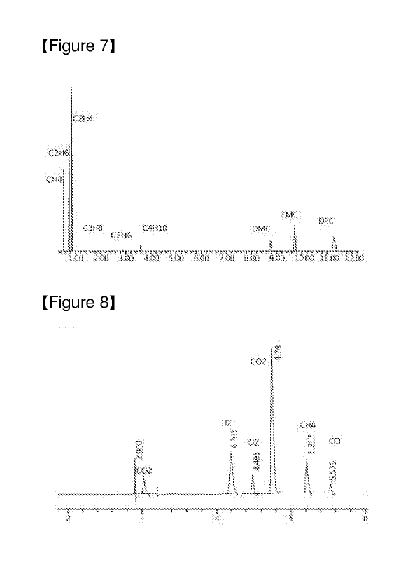

The analysis results of the organic gas analyzed through the flame ionization detector are shown in FIG. 7. The analysis results of carbon dioxide and the fixed gas analyzed by thermal conductivity detector are shown in FIG. 8.

Through the analysis results described as the above, it was recognized that, according to the present invention, the total analysis time is less than 15 minutes, and thereby it is possible to analyze the organic gas and the fixed gas simultaneously within a much faster time, compared to the conventional analysis method.

1. An apparatus for a high-speed analysis of a gas sample using gas chromatography comprising:
an organic gas analyzing part comprising a switching valve, a column, and a flame ionization detector (FID); and
a fixed gas analysis part comprising a plurality of switching valves, three or more columns comprising a column for electrolyte separation, a column for carbon dioxide separation, and a column for separating fixed gas, a pressure controller, and a thermal conductivity detector (TCD).

2. The apparatus for a high-speed analysis of a gas sample using gas chromatography according to claim 1,
wherein the organic gas is any one or more selected from the group consisting of CₙH₂ₙ₋₂ (n=2 to 5), CₙH₂ₙ (n=2 to 5), and Cₙ H₂ₙ₊₂ (n=1 to 5), and the fixed gas is any one or more selected from the group consisting of hydrogen (H₂), oxygen (O₂), nitrogen (N₂), carbon monoxide (CO), and carbon dioxide (CO₂).

3. (canceled)

4. The apparatus for a high-speed analysis of a gas sample using gas chromatography according to claim 1,
wherein the flame ionization detector (FID) is connected in parallel or in series with other detectors, and the thermal conductivity detector (TCD) is connected in parallel or in series with other detectors.

5. (canceled)

6. The apparatus for a high-speed analysis of a gas sample using gas chromatography according to claim 1,
wherein the switching valve is a six-port valve or a ten-port valve.

7. The apparatus for a high-speed analysis of a gas sample using gas chromatography according to claim 1,
wherein the pressure controller independently controls the pressures of the argon (Ar) gas at two or more column inlets to transfer the fixed gas, the organic gas, and the electrolyte.

8. The gas sample injection apparatus for gas chromatographic analysis according to claim 1,
wherein the column of the organic gas analyzing part separates the organic gas components, and is a PLOT (Porous Layer Open Tubular)-based column.

9. (canceled)

10. The apparatus for a high-speed analysis of a gas sample using gas chromatography according to claim 1,
wherein the switching valve of the organic gas analyzing part further comprises a gas loop.

11. The apparatus for a high-speed analysis of a gas sample using gas chromatography according to claim 1,
wherein among the three or more columns, the column for electrolyte separation and the column for carbon dioxide separation are PLOT (Porous Layer Open Tubular)-based columns, and the column for fixed gas separation is a molecular sieve.

12. (canceled)

13. The apparatus for a high-speed analysis of a gas sample using gas chromatography according to claim 1,
wherein among the three or more columns, the column for electrolyte separation separates the electrolyte from the fixed gas and a portion of the organic gas and then discharges it out of the column

14. The apparatus for a high-speed analysis of a gas sample using gas chromatography according to claim 1,
wherein among the three or more columns, the column for the carbon dioxide separation separates the carbon dioxide from the remaining fixed gas and then bypasses it to the thermal conductivity detector (TCD) through a bypass tube.

15. The apparatus for a high-speed analysis of a gas sample using gas chromatography according to claim 1,
wherein among the three or more columns, the column for fixed gas separation separate the fixed gas and then discharge it to the thermal conductivity detector (TCD).

16. The apparatus for a high-speed analysis of a gas sample using gas chromatography according to claim 1,
wherein the apparatus for a high-speed analysis of a gas sample is for analyzing a gas sample mixed with an organic gas and a fixed gas, and is for analyzing a gas generated inside a cell
wherein the cell is a lithium ion battery.

17. (canceled)

18. (canceled)

19. A method for a high-speed analysis of a gas sample using gas chromatography comprising the steps of:
a) injecting a mixed gas of an organic gas and a fixed gas;
b) sending a portion of the injected gas into a column for organic gas separation and separating the organic gas, and then analyzing the separated organic gas with a flame ionization detector (FID);
c) separating the injected gas by sending it into a column for electrolyte separation, a column for carbon dioxide separation, and a column for fixed gas separation;
d) discharging the electrolyte remaining in the column for electrolyte separation;
e) separating the carbon dioxide with the column for carbon dioxide separation and bypassing it to a thermal conductivity detector (TCD); and
f) separating the fixed gas with the column for fixed gas separation and then sending it to a thermal conductivity detector (TCD).

20. The method for a high-speed analysis of a gas sample using gas chromatography according to claim 19,
wherein the method uses an apparatus comprising:
an organic gas analyzing part comprising a switching valve, the column for organic gas separation, and the flame ionization detector (FID); and
a fixed gas analysis part comprising a plurality of switching valves, three or more columns comprising the column for electrolyte separation, the column for carbon dioxide separation, and the column for separating a fixed gas, a pressure controller, and the thermal conductivity detector (TCD).

21. The method for a high-speed analysis of a gas sample using gas chromatography according to claim 19,
wherein the organic gas is any one or more selected from the group consisting of CₙH₂ₙ₋₂ (n=2 to 5), CₙH₂ₙ (n=2 to 5), and CₙH₂ₙ₊₂ (n=1 to 5), and the fixed gas is any one or more selected from the group consisting of hydrogen (H₂), oxygen (O₂), nitrogen (N₂), carbon monoxide (CO), and carbon dioxide (CO₂).

22. (canceled)

23. The method for a high-speed analysis of a gas sample using gas chromatography according to claim 19,
wherein the flame ionization detector (FID) is connected in parallel or in series with other detectors, and the thermal conductivity detector (TCD) is connected in parallel or in series with other detectors.

24. (canceled)

25. The method for a high-speed analysis of a gas sample using gas chromatography according to claim 19,
wherein movements of the fixed gas, the organic gas, and the electrolyte in the analysis method are controlled by using a switching valve and a pressure controller,
wherein the switching valve is a six-port valve or a ten-port valve, and
wherein the pressure controller independently controls the pressures of the argon (Ar) gas at two or more column inlets to transfer the fixed gas, the organic gas, and the electrolyte.

26. (canceled)

27. (canceled)

28. The method for a high-speed analysis of a gas sample using gas chromatography according to claim 19,
wherein the column for organic gas separation is a PLOT (Porous Layer Open Tubular)-based column, the column for electrolyte separation and the column for carbon dioxide separation are PLOT (Porous Layer Open Tubular)-based columns, and the column for fixed gas separation is a molecular sieve.

29. (canceled)

30. (canceled)

31. The method for a high-speed analysis of a gas sample using gas chromatography according to claim 19,
wherein the method for a high-speed analysis of a gas sample is for analyzing a gas sample mixed with an organic gas and a fixed gas.

32. The method for a high-speed analysis of a gas sample using gas chromatography according to claim 19,
wherein the method for a high-speed analysis of a gas sample is for analyzing a gas generated inside a cell, and
wherein the cell is a lithium ion battery.

33. (canceled)
